(19) United States
(12) Patent Application Publication
(10) Pub. No.: US 2025/0092874 A1
(43) Pub. Date: Mar. 20, 2025

(54) ELECTRIC COMPRESSOR

(71) Applicant: Hanon Systems, Daejeon (KR)

(72) Inventors: Seung Kyu Na, Daejeon (KR); Eun Gi Son, Daejeon (KR); Tae Ho Lee, Daejeon (KR); Bok Ki Park, Daejeon (KR)

(21) Appl. No.: 18/580,807

(22) PCT Filed: Nov. 7, 2022
(86) PCT No.: PCT/KR2022/017350

§ 371 Date: Jan. 19, 2024

(30) Foreign Application Priority Data
Dec. 7, 2021 (KR) 10-2021-0174010

(51) Int. Cl. F04C 29/04; F04C 18/02; F04C 23/02; H02K 5/18

(52) U.S. Cl. CPC F04C 29/047; F04C 23/02; H02K 5/18; F04C 18/0215; F04C 2240/403

(57) ABSTRACT

An electric compressor including a motor configured to generate power; a compression mechanism configured to receive the power from the motor and compress a refrigerant; and an inverter configured to control the motor. A housing receiving the motor and the inverter includes a partition wall that divides a motor receiving space receiving the motor and an inverter receiving space receiving the inverter, and a suction port guiding the refrigerant to the motor receiving space. The partition wall includes a rib that protrudes from a surface facing the motor receiving space. As a result, it is possible to sufficiently cool a plurality of elements of an inverter as a whole and to suppress temperature deviation between the plurality of elements, thereby suppressing damage, operation stop, and increase in maintenance cost.

### CROSS REFERENCE TO RELATED PATENT APPLICATIONS

This is a U.S. national phase patent application of PCT/KR2022/017350 filed Nov. 7, 2022 which claims the benefit of and priority to Korean Patent Application No. 10-2021-0174010, filed on Dec. 7, 2021, the entire contents of each of which are incorporated herein by reference.

### TECHNICAL FIELD

The present disclosure relates to an electric compressor and more particularly to an electric compressor capable of compressing a refrigerant by a driving force of a motor that is controlled by an inverter.

### BACKGROUND ART

In general, a compressor is a device for compressing a fluid such as a refrigerant gas, etc., and is applied to an air-conditioning system of a building, an air-conditioning system for a vehicle, etc.

The compressor may be divided, according to a compression type, into a reciprocating type compressor that compresses the refrigerant through a reciprocating motion of a piston and a rotary type compressor that compresses the refrigerant while rotating. The reciprocating type compressor may be divided into a crank type compressor that transmits power to a plurality of pistons by using a crank according to a power transmission method, a swash plate type compressor that transmits power to a rotating shaft on which the swash plate is installed, etc. The rotary type compressor may be divided into a vane rotary type compressor using a rotating shaft and a vane and a scroll type compressor using an orbiting scroll and a fixed scroll.

Also, the compressor may be divided according to a driving method into a mechanical compressor that uses an engine and an electric compressor that uses a motor.

Here, an inverter that controls a motor in order to control compression capacity is applied to the electric compressor, and a structure for cooling the heating element of the inverter is applied.

FIG. 1 is a cross-sectional view showing a conventional electric compressor. FIG. 2 is a perspective view showing a partially cut front housing of the electric compressor of FIG. 1. FIG. 3 is a temperature distribution chart showing temperature distribution of an inverter element of the electric compressor of FIG. 1. For reference, FIG. 3 shows that the higher the temperature, the darker shades.

Referring to attached FIGS. 1 to 3, a conventional electric compressor includes a motor 6 that generates power, a compression mechanism 4 that receives the power from the motor 6 and compresses a refrigerant, and an inverter 8 that controls the motor 6. A housing 2 receiving the motor 6 and the inverter 8 includes a partition wall 242 and a suction port 2442. The partition wall 242 divides a motor receiving space S1 that receives the motor 30 and an inverter receiving space S2 that receives the inverter 8. The suction port 2442 guides the refrigerant to the motor receiving space S1. The inverter 8 includes a plurality of elements 84. At least some of the plurality of elements 84 come into contact with the partition wall 242 in the inverter receiving space S2.

Meanwhile, the housing 2 includes an annular wall 244 and a plurality of internal flow paths 2444. The annular wall 244 supports an outer peripheral surface of the motor 6. The plurality of internal flow paths 2444 is formed concavely on an inner peripheral surface of the annular wall 244, is spaced apart from the outer peripheral surface of the motor 6, and extends toward the compression mechanism 4.

In the conventional electric compressor according to such a configuration, when power is applied to the motor 6, the refrigerant flows into the motor receiving space S1 through the suction port 2442, and the refrigerant in the motor receiving space S1 flows into the compression mechanism 4 through the plurality of internal flow paths 2444, is compressed, and is then discharged to the outside of the housing 2.

Also, in this process, the motor 6 is controlled by the inverter 8, so that the cooling efficiency is variably controlled. Heat generated from the element 84 of the inverter 8 is radiated to the refrigerant in the motor receiving space S1 through the partition wall 242.

However, in such a conventional electric compressor, the plurality of elements 84 of the inverter 8 is not sufficiently cooled as a whole, and a temperature deviation occurs between the plurality of elements 84 as shown in FIG. 3, resulting in damage of the element 84 of the inverter 8 by fire, the operation stop of the electric compressor, and increase in maintenance cost accordingly.

### SUMMARY

The purpose of the present disclosure is to provide an electric compressor capable of sufficiently cooling a plurality of elements of an inverter as a whole and of suppressing temperature deviation between the plurality of elements, thereby suppressing damage, operation stop, and increase in maintenance cost.

An embodiment is an electric compressor including: a motor configured to generate power; a compression mechanism configured to receive the power from the motor and compress a refrigerant; and an inverter configured to control the motor. A housing receiving the motor and the inverter includes a partition wall that divides a motor receiving space receiving the motor and an inverter receiving space receiving the inverter, and a suction port guiding the refrigerant to the motor receiving space. The partition wall includes a rib that protrudes from a surface facing the motor receiving space.

A part of the refrigerant that has flowed from the suction port to the motor receiving space may flow in a circumferential direction of the motor receiving space. The rib may include a first rib extending in a radial direction of the motor receiving space.

The first rib may be formed in plural numbers. The plurality of first ribs may be arranged in the circumferential direction of the motor receiving space.

The partition wall may further include an annular boss portion protrudes from the surface facing the motor receiving space of the partition wall such that a bearing that supports a rotary shaft of the motor is inserted. The plurality of first ribs may extend from the boss portion.

The housing may further include an annular wall that extends from an outer periphery of the partition wall. Some of the plurality of first ribs may extend from the boss portion to the annular wall.

At least some of the plurality of first ribs may be formed to have different lengths.

The suction port may be formed on a side opposite to the direction of gravity with respect to the center of the motor receiving space. The plurality of first ribs may be formed such that an average length of the first ribs formed on a side in the direction of gravity with respect to the center of the motor receiving space is greater than an average length of the first ribs formed on a side opposite to the direction of gravity with respect to the center of the motor receiving space.

The housing may further include an annular wall that supports an outer peripheral surface of the motor, and an internal flow path that is formed concavely on an inner peripheral surface of the annular wall, is spaced apart from the outer peripheral surface of the motor, and extends toward the compression mechanism.

The internal flow path may be formed in plural numbers. The plurality of internal flow paths may be arranged in the circumferential direction of the motor receiving space, and include an upstream internal flow path that is located adjacent to an outlet of the suction port and a downstream internal flow path that is located far away from the outlet of the suction port based on the circumferential direction of the motor receiving space in an extension direction of the suction port.

A flow cross-sectional area of the downstream internal flow path may be larger than a flow cross-sectional area of the upstream internal flow path.

The rib may further include a second rib which extends in the circumferential direction of the motor receiving space.

The second rib may extend from the upstream internal flow path side to the downstream internal flow path side.

The second rib may have a radius of curvature that decreases the closer it is to the downstream internal flow path in the circumferential direction of the motor receiving space.

A protrusion height of the second rib may be formed greater than a protrusion height of the first rib.

The second rib may be formed in plural numbers. The plurality of second ribs may be arranged in the radial direction of the motor receiving space.

The plurality of second ribs may be formed to be spaced apart from each other in the radial direction of the motor receiving space. A spaced distance between the plurality of second ribs at a position adjacent to the suction port in the circumferential direction of the motor receiving space may be larger than a spaced distance between the plurality of second ribs at a position remote from the suction port.

The plurality of second ribs may include a centripetal rib and a centrifugal rib that is formed on a radially outer side of the motor receiving space with respect to the centripetal rib. A circumferential length of the centripetal rib may be greater than a circumferential length of the centrifugal rib.

A leading edge of the centripetal rib may be formed to overlap a leading edge of the centripetal rib in the radial direction of the motor receiving space. A trailing edge of the centripetal rib may be formed in such a manner as not to overlap a trailing edge of the centripetal rib in the radial direction of the motor receiving space.

The inverter may include a plurality of elements. At least some of the plurality of elements may come into contact with the partition wall in the inverter receiving space.

The plurality of elements may be a switching element

Another embodiment is an electric compressor including: a motor configured to generate power; a compression mechanism configured to receive the power from the motor and compress a refrigerant; and an inverter configured to control the motor. A housing receiving the motor and the inverter includes a partition wall that divides a motor receiving space receiving the motor and an inverter receiving space receiving the inverter, a suction port that causes a low-temperature refrigerant to flow into the motor receiving space in a circumferential direction of the motor receiving space, an annular wall that supports an outer peripheral surface of the motor, and an internal flow path that is formed concavely on an inner peripheral surface of the annular wall, is spaced apart from the outer peripheral surface of the motor, and extends toward the compression mechanism. The internal flow path is formed in plural numbers. The plurality of internal flow paths is arranged in the circumferential direction of the motor receiving space, and include an upstream internal flow path that is located adjacent to an outlet of the suction port and a downstream internal flow path that is located far away from the outlet of the suction port based on the circumferential direction of the motor receiving space in an extension direction of the suction port. A flow cross-sectional area of the downstream internal flow path is larger than a flow cross-sectional area of the upstream internal flow path.

The electric compressor according to the present disclosure includes: a motor configured to generate power; a compression mechanism configured to receive the power from the motor and compress a refrigerant; and an inverter configured to control the motor. A housing receiving the motor and the inverter includes a partition wall that divides a motor receiving space receiving the motor and an inverter receiving space receiving the inverter, and a suction port guiding the refrigerant to the motor receiving space. The partition wall includes a rib that protrudes from a surface facing the motor receiving space. As a result, it is possible to sufficiently cool a plurality of elements of an inverter as a whole and to suppress temperature deviation between the plurality of elements, thereby suppressing damage, operation stop, and increase in maintenance cost.

### DESCRIPTION OF DRAWINGS

FIG. 1 is a cross-sectional view showing a conventional electric compressor;

FIG. 2 is a perspective view showing a partially cut front housing of the electric compressor of FIG. 1;

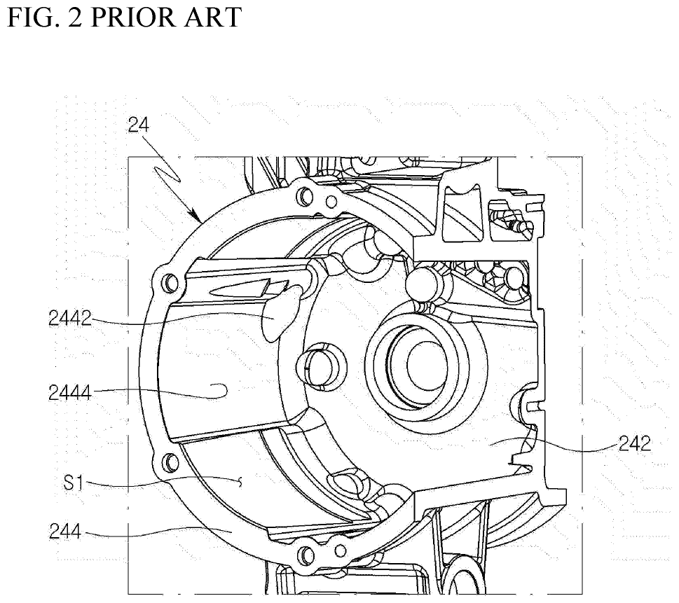

FIG. 3 is a temperature distribution chart showing temperature distribution of an inverter element of the electric compressor of FIG. 1;

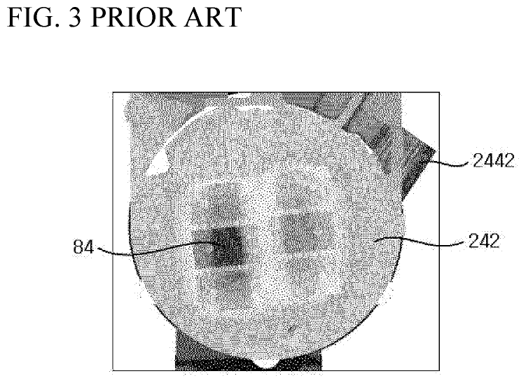

FIG. 4 is a perspective view showing a partially cut front housing of an electric compressor according to an embodiment of the present disclosure;

FIG. 5 is a front view of FIG. 4;

FIG. 6 is a front view showing some parts of a motor are received in the front housing of FIG. 5;

FIG. 7 is a temperature distribution chart showing temperature distribution of an inverter element of the electric compressor of FIG. 4;

FIG. 8 is a perspective view showing a partially cut front housing of an electric compressor according to another embodiment of the present disclosure; and

FIG. 9 is a front view of FIG. 8.

### DESCRIPTION OF AN EMBODIMENT

Hereinafter, an electric compressor according to an embodiment of the present disclosure will be described in detail with reference to the accompanying drawings.

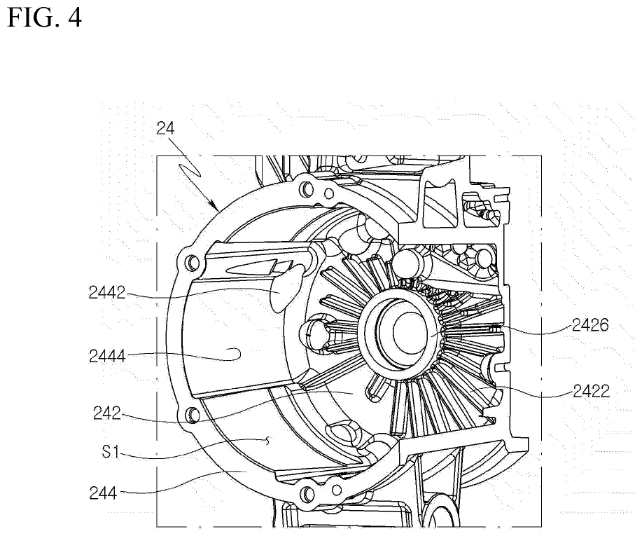

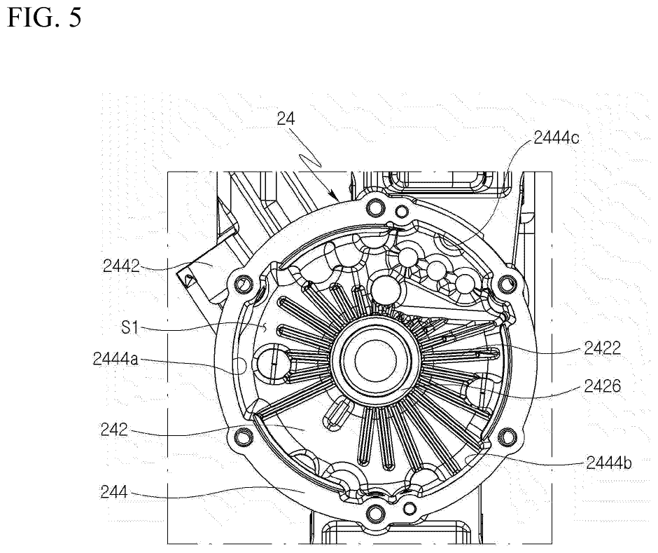

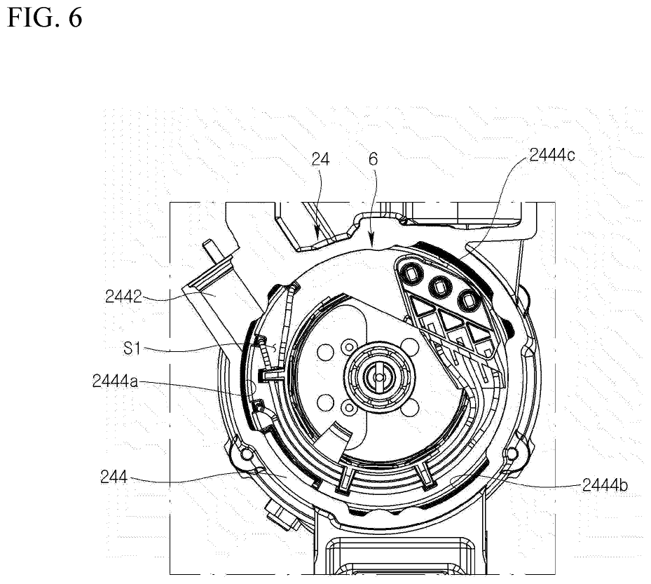

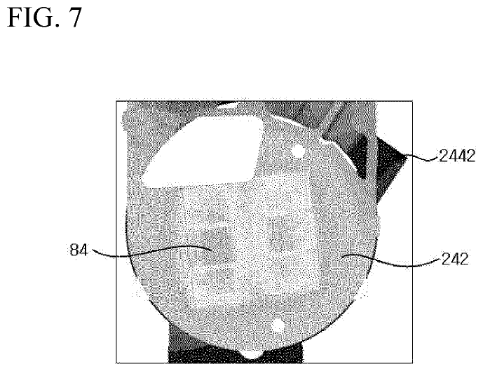

FIG. 4 is a perspective view showing a partially cut front housing of an electric compressor according to an embodiment of the present disclosure. FIG. 5 is a front view of FIG. 4. FIG. 6 is a front view showing some parts of a motor are received in the front housing of FIG. 5. FIG. 7 is a temperature distribution chart showing temperature distribution of an inverter element of the electric compressor of FIG. 4.

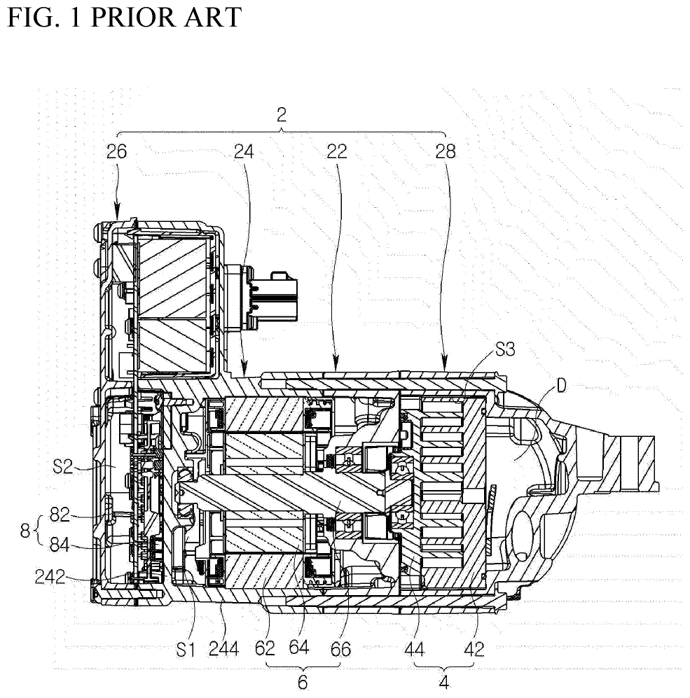

Meanwhile, reference is made to FIG. 1 for the description of components unshown in FIGS. 4 to 7.

Referring to the attached FIGS. 4 to 7 and FIG. 1, the electric compressor according to the embodiment of the present disclosure may include a housing 2, a compression mechanism 4 that is within the housing 2 and compresses a refrigerant, a motor 6 that provides power to the compression mechanism 4, and an inverter 8 that controls the motor 6.

The housing 2 includes a center housing 22, a front housing 24 that is coupled to the center housing 22 and forms a motor receiving space S1 in which the motor 6 is received, an inverter cover 26 that is coupled to the front housing 24 on the opposite side of the center housing 22 with respect to the front housing 24 and forms an inverter receiving space S2 in which the inverter 8 is received, and a rear housing 28 that is coupled to the center housing 22 on the opposite side of the front housing 24 with respect to the center housing 22 and forms a compression mechanism receiving space S3 in which the compression mechanism 4 is received and a discharge chamber D in which the refrigerant discharged from the compression mechanism 4 is received.

Here, the front housing 24 may include a partition wall 242 and an annular wall 244. The partition wall 242 divides the motor receiving space S1 and the inverter receiving space S2. The annular wall 244 extends from an outer periphery of the partition wall 242 and supports an outer peripheral surface of the motor 6.

The partition wall 242 may include a first surface that faces the motor receiving space S1 and a second surface that forms a back side of the first surface and faces the inverter receiving space S2.

The first surface may include an annular boss portion 2426 that protrudes from the center of the first surface toward the motor receiving space S1. A bearing that supports a rotary shaft 66 to be described later may be inserted into the boss portion 2426.

Also, the first surface may further include a rib protruding from the first surface toward the motor receiving space S1.

The rib may include a first rib 2422 extending in the radial direction of the motor receiving space S1.

The first rib 2422 may be formed in plural numbers, and the plurality of first ribs 2422 may be arranged in the circumferential direction of the motor receiving space S1. The plurality of first ribs 2422 may extend from the boss portion 2426.

Here, some of the plurality of first ribs 2422 may extend from the boss portion 2426 to the annular wall 244.

Also, at least some of the plurality of first ribs 2422 may be formed to have different lengths.

Also, a suction port 2442 is formed on a side opposite to the direction of gravity with respect to the center of the motor receiving space S1, and the plurality of first ribs 2422 may be formed such that an average length of the first ribs formed on the side in the direction of gravity with respect to the center of the motor receiving space S1 is greater than an average length of the first ribs formed on the side opposite to the direction of gravity with respect to the center of the motor receiving space S1.

The second surface may be formed in a flat shape so as to come into contact with an element 84 of the inverter 8, which will be described later.

The annular wall 244 may include the suction port 2442 that guides a low-temperature refrigerant to the motor receiving space S1.

The suction port 2442 may be formed to allow a part of the refrigerant that has flowed from the suction port 2442 to the motor receiving space SI to flow in the circumferential direction of the motor receiving space S1.

Also, the annular wall 244 may further include an internal flow path 2444 that is formed concavely on an inner peripheral surface of the annular wall 244, is spaced apart from the outer peripheral surface of the motor 6, and extends toward the compression mechanism 4.

The internal flow path 2444 may be formed in plural numbers. The plurality of internal flow paths 2444 may include an upstream internal flow path and a downstream internal flow path. The upstream internal flow path is arranged in the circumferential direction of the motor receiving space S1 and is located adjacent to an outlet of the suction port 2442 on the basis of the circumferential direction of the motor receiving space S1 in the extension direction of the suction port 2442. The downstream internal flow path is located far away from the outlet of the suction port 2442.

Here, the flow cross-sectional area of the downstream internal flow path may be larger than the flow cross-sectional area of the upstream internal flow path.

Here, the upstream internal flow path may be referred to as the internal flow path that is located adjacent to an outlet of the suction port 2442 on the basis of the circumferential direction of the motor receiving space S1 in the extension direction of the suction port 2442. The downstream internal flow path may be referred to as the internal flow path that is located far away from the outlet of the suction port 2442. Accordingly, in the embodiment, as a non-limiting embodiment, the plurality of internal flow paths 2444 may include three internal flow paths, that is, the plurality of internal flow paths 2444 may include a first internal flow path 2444a, a second internal flow path 2444b, and a third internal flow path 2444c. The first internal flow path 2444a is disposed on the outlet side of the suction port 2442. The second internal flow path 2444b is disposed further downstream than the first internal flow path 2444a. The third internal flow path 2444c is disposed further downstream than the second internal flow path 2444b. The first internal flow path 2444a is an upstream internal flow path of the second internal flow path 2444b and the third internal flow path 2444c. The second internal flow path 2444b is a downstream internal flow path of the first internal flow path 2444b and is an upstream internal flow path of the third internal flow path 2444c. The third internal flow path 2444c is a downstream internal flow path of the first internal flow path 2444b and the second internal flow path 2444b. Also, the flow cross-sectional area of the third internal flow path 2444c may be larger than the flow cross-sectional area of the second internal flow path 2444b, and the flow cross-sectional area of the first internal flow path 2444a may be less than the flow cross-sectional area of the second internal flow path 2444b.

The compression mechanism 4 may include a fixed scroll 42 that is fixedly installed thereon and an orbiting scroll 44 that is engaged with the fixed scroll 42, forms, together with the fixed scroll 42, a compression chamber, and performs an orbiting motion by the rotary shaft 66 to be described later. Here, in the embodiment, the compression mechanism 4 is formed in a so-called scroll type, and is not limited to this. The compression mechanism 4 may be formed in different types such as in a reciprocating type, in a vane rotary type, etc.

The motor 6 may include a stator 62 supported on the annular wall 244, a rotor 64 that is located within the stator 62 and is rotated by the interaction with the stator 62, and the rotary axis 66 that rotates together with the rotor 64.

The inverter 8 may include a substrate 82 on which a plurality of the elements 84 required for control are mounted.

Here, the plurality of elements 84 includes a heating element such as a switching element, for example, an insulated gate bipolar transistor (IGBT), an intelligent power module (IPM), etc. At least a portion of the heating element may be in contact with the partition wall 242 (more precisely, the second surface) for heat radiation.

Hereinafter, the operational effects of the electric compressor according to the embodiment will be described.

That is, when power is applied to the motor 6, low-temperature, the low-pressure and low-pressure refrigerant flows into the motor receiving space S1 through the suction port 2442, and the refrigerant in the motor receiving space S1 flows into the compression mechanism 4 through the plurality of internal flow paths 2444, is compressed at high temperature and high pressure, and is then discharged to the outside of the housing 2 through the discharge chamber D.

Also, in this process, the motor 6 is controlled by the inverter 8, so that the cooling efficiency is variably controlled. Heat generated from the plurality of elements 84 is radiated to the refrigerant in the motor receiving space S1 through the partition wall 242.

Here, the electric compressor according to the embodiment includes the first rib 2422 protruding from the first surface of the partition wall 242, so that a heat exchange area between the partition wall 242 and the refrigerant in the motor receiving space S1 is increased, and thus, heat radiation performance is improved, and the plurality of elements 84 can be sufficiently cooled as a whole. As a result, it is possible to prevent damage of the element 84 by fire, the operation stop of the electric compressor, and to reduce maintenance costs.

Also, as the first rib 2422 extends in the radial direction of the motor receiving space S1, a flow resistance to the refrigerant in the motor receiving space S1 increases, so that a flow rate of the refrigerant in the motor receiving space S1 may be reduced. As a result, heat exchange time between the partition wall 242 and the refrigerant in the motor receiving space S1 is increased, and thus, the heat radiation performance can be further improved.

Also, as the first rib 2422 may be formed in plural numbers and the plurality of first ribs 2422 is arranged in the circumferential direction of the motor receiving space S1, the heat exchange area is further increased and the flow resistance is further increased, so that the heat radiation performance can be further improved.

Also, as the flow cross-sectional area of the downstream internal flow path 2444 is formed to be larger than the flow cross-sectional area of the upstream internal flow path, the temperature deviation between the plurality of elements 84 can be, as shown in FIG. 7, reduced.

Specifically, unlike the embodiment, when the flow cross-sectional area of the upstream internal flow path and the flow cross-sectional area of the downstream internal flow path are formed to be equal to each other, the flow rate of the refrigerant passing through the downstream internal flow path is reduced than the flow rate of the refrigerant passing through the upstream internal flow path due to a travel distance of the refrigerant, the flow resistance, etc. Also, due to such flow rate non-uniformity according to the flow path, the temperature deviation between the plurality of elements 84 increases, and some of the plurality of elements 84 overheat and are damaged by fire.

However, in the case of the embodiment, as the flow cross-sectional area of the downstream internal flow path is formed to be larger than the flow cross-sectional area of the upstream internal flow path, the flow rate of the refrigerant passing through the downstream internal flow path is at an equal level to the flow rate of the refrigerant passing through the upstream internal flow path. In other words, the flow rate according to the flow path can be equalized. As a result, the temperature deviation between the plurality of elements 84 can be reduced, and overheating of some of the plurality of elements 84 can be suppressed.

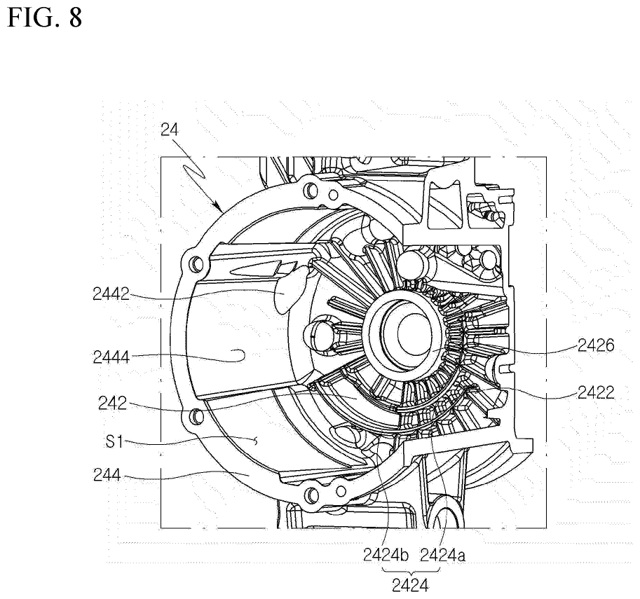

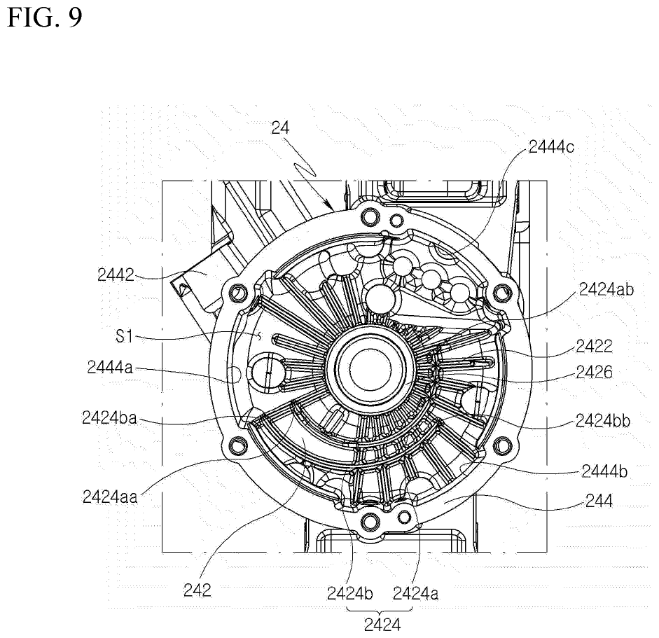

Meanwhile, in the embodiment, the first rib 2422 is formed. However, as shown in FIGS. 8 and 9, a second rib 2424 protruding from the first surface of the partition wall 242 is further formed. Therefore, the heat exchange area between the partition wall 242 and the refrigerant in the motor receiving space S1 may be further increased.

Also, the second rib 2424 extends in the circumferential direction of the motor receiving space S1 in such a way as to guide the refrigerant in the motor receiving space S1 to the downstream internal flow path, the flow rate uniformity according to the flow path can be achieved more easily.

Here, in order that the refrigerant in the motor receiving space S1 is guided to the downstream internal flow path by the second rib 2424 while receiving the flow resistance by the first rib 2422 and the heat exchange area is further increased, the protrusion height of the second rib 2424 may be formed greater than the protrusion height of the first rib 2422.

In addition, in terms of the flow rate uniformity according to the flow path, it may be desirable that the second rib 2424 should extend from the upstream internal flow path side to the downstream internal flow path side and should have a radius of curvature that decreases the closer it is to the downstream internal flow path (that is, in the counterclockwise direction in FIG. 9) in the circumferential direction of the motor receiving space S1.

Also, as the second rib 2424 may be formed in plural numbers and the plurality of second ribs 2424 is arranged in the radial direction of the motor receiving space S1, the heat exchange area is further increased and the flow rate uniformity according to the flow path can be achieved more easily.

Here, the plurality of second ribs 2424 is formed to be spaced apart from each other in the radial direction of the motor receiving space S1. In order to allow the refrigerant to easily flow into a space between the plurality of second ribs 2424, it is preferable that a spaced distance between the plurality of second ribs 2424 at a position adjacent to the suction port 2442 in the circumferential direction of the motor receiving space S1 should be larger than a spaced distance between the plurality of second ribs 2424 at a position remote from the suction port 2442.

Also, in terms of the flow rate uniformity according to the flow path, the plurality of second ribs 2424 includes a centripetal rib 2424a and a centrifugal rib 2424b that is formed on the radially outer side of the motor receiving space S1 with respect to the centripetal rib 2424a. It may be desirable that a circumferential length of the centripetal rib 2424a should be greater than a circumferential length of the centrifugal rib 2424b.

Also, it may be more desirable that a leading edge 2424aa of the centripetal rib 2424a is formed to overlap a leading edge 2424ba of the centripetal rib 2424b in the radial direction of the motor receiving space S1 and a trailing edge 2424ab of the centripetal rib 2424a is formed in such a manner as not to overlap a trailing edge 2424bb of the centripetal rib 2424b in the radial direction of the motor receiving space S1.

Here, in the above-described embodiments, the provision of the first rib 2422 causes the flow cross-sectional area of the downstream internal flow path to be larger than the flow cross-sectional area of the upstream internal flow path, or alternatively, the provision of the first rib 2422 and the second rib 2424 causes the flow cross-sectional area of the downstream internal flow path to be larger than the flow cross-sectional area of the upstream internal flow path. However, the embodiments are not limited to this. That is, for example, the first rib 2422 and the second rib 2424 are provided, and the flow cross-sectional area of the downstream internal flow path may be is at an equal level to the flow cross-sectional area of the upstream internal flow path. As another example, the first rib 2422 may be omitted while the second rib 2424 is provided. However, in terms of the heat radiation performance maximization and the flow rate uniformity according to the flow path, it may be preferable that the rib should be formed as in the above-described embodiments.

1-20. (canceled)

21. An electric compressor comprising:
a motor configured to generate power;
a compression mechanism configured to receive the power from the motor and compress a refrigerant; and
an inverter configured to control the motor, wherein a housing receiving the motor and the inverter further comprises a partition wall that divides a motor receiving space receiving the motor and an inverter receiving space receiving the inverter, and a suction port guiding the refrigerant to the motor receiving space, and wherein the partition wall further comprises a rib that protrudes from a surface facing the motor receiving space.

22. The electric compressor of claim 21, wherein a part of the refrigerant that has flowed from the suction port to the motor receiving space flows in a circumferential direction of the motor receiving space, and wherein the rib further comprises a first rib extending in a radial direction of the motor receiving space.

23. The electric compressor of claim 22, wherein there are a plurality of first ribs, and wherein the plurality of first ribs is arranged in the circumferential direction of the motor receiving space.

24. The electric compressor of claim 23, wherein the partition wall further comprises an annular boss portion protruding from the surface facing the motor receiving space of the partition wall such that a bearing that supports a rotary shaft of the motor is inserted, and wherein the plurality of first ribs extends from the boss portion.

25. The electric compressor of claim 24, wherein the housing further comprises an annular wall that extends from an outer periphery of the partition wall, and wherein some of the plurality of first ribs extend from the boss portion to the annular wall.

26. The electric compressor of claim 23, wherein at least some of the plurality of first ribs are formed to have different lengths.

27. The electric compressor of claim 26, wherein the suction port is formed on a side opposite to a direction of gravity with respect to the center of the motor receiving space, and wherein the plurality of first ribs is formed such that an average length of a first portion of the plurality of first ribs formed on a side in the direction of gravity with respect to the center of the motor receiving space is greater than an average length of a second portion of the plurality first ribs formed on a side opposite to the direction of gravity with respect to the center of the motor receiving space.

28. The electric compressor of claim 22, wherein the housing further comprises an annular wall that supports an outer peripheral surface of the motor, and an internal flow path that is formed concavely on an inner peripheral surface of the annular wall, is spaced apart from the outer peripheral surface of the motor, and extends toward the compression mechanism.

29. The electric compressor of claim 28, wherein there are a plurality of internal flow paths, and wherein the plurality of internal flow paths is arranged in the circumferential direction of the motor receiving space, and further comprises an upstream internal flow path that is located adjacent to an outlet of the suction port and a downstream internal flow path that is located far away from the outlet of the suction port based on the circumferential direction of the motor receiving space in an extension direction of the suction port.

30. The electric compressor of claim 29, wherein a flow cross-sectional area of the downstream internal flow path is larger than a flow cross-sectional area of the upstream internal flow path.

31. The electric compressor of claim 29, wherein the rib further comprises a second rib which extends in the circumferential direction of the motor receiving space.

32. The electric compressor of claim 31, wherein the second rib extends from the upstream internal flow path side to the downstream internal flow path side.

33. The electric compressor of claim 32, wherein the second rib has a radius of curvature that decreases the closer it is to the downstream internal flow path in the circumferential direction of the motor receiving space.

34. The electric compressor of claim 31, wherein a protrusion height of the second rib is formed greater than a protrusion height of the first rib.

35. The electric compressor of claim 31, wherein there is a plurality of second ribs, and wherein the plurality of second ribs is arranged in the radial direction of the motor receiving space.

36. The electric compressor of claim 35, wherein the plurality of second ribs is formed to be spaced apart from each other in the radial direction of the motor receiving space, and wherein a spaced distance between the plurality of second ribs at a position adjacent to the suction port in the circumferential direction of the motor receiving space is larger than a spaced distance between the plurality of second ribs at a position remote from the suction port.

37. The electric compressor of claim 35, wherein the plurality of second ribs further comprises a centripetal rib and a centrifugal rib that is formed on a radially outer side of the motor receiving space with respect to the centripetal rib, and wherein a circumferential length of the centripetal rib is greater than a circumferential length of the centrifugal rib.

38. The electric compressor of claim 37, wherein a leading edge of the centripetal rib is formed to overlap a leading edge of the centripetal rib in the radial direction of the motor receiving space, and wherein a trailing edge of the centripetal rib is formed in such a manner as not to overlap a trailing edge of the centripetal rib in the radial direction of the motor receiving space.

39. The electric compressor of claim 21, wherein the inverter further comprises a plurality of elements, wherein at least some of the plurality of elements come into contact with the partition wall in the inverter receiving space, and wherein the plurality of elements is a switching element.

40. An electric compressor comprising:
a motor configured to generate power;
a compression mechanism configured to receive the power from the motor and compress a refrigerant; and
an inverter configured to control the motor, wherein a housing receiving the motor and the inverter further comprises a partition wall that divides a motor receiving space receiving the motor and an inverter receiving space receiving the inverter, a suction port that causes a low-temperature refrigerant to flow into the motor receiving space in a circumferential direction of the motor receiving space, an annular wall that supports an outer peripheral surface of the motor, and an internal flow path that is formed concavely on an inner peripheral surface of the annular wall, is spaced apart from the outer peripheral surface of the motor, and extends toward the compression mechanism, wherein there is a plurality of internal flow paths, wherein the plurality of internal flow paths is arranged in the circumferential direction of the motor receiving space, and includes an upstream internal flow path that is located adjacent to an outlet of the suction port and a downstream internal flow path that is located far away from the outlet of the suction port based on the circumferential direction of the motor receiving space in an extension direction of the suction port, and wherein a flow cross-sectional area of the downstream internal flow path is larger than a flow cross-sectional area of the upstream internal flow path.
